(19) United States
(12) Patent Application Publication
(10) Pub. No.: US 2004/0020698 A1
(43) Pub. Date: Feb. 5, 2004

(54) Driver assistance system

(76) Inventors: Helmar-Steffen Gehrke, Eberdingen/Hochdorf (DE); Clemens Guenther, Ettlingen (DE); Albrecht Irion, Stuttgart (DE)

Correspondence Address: KENYON & KENYON, ONE BROADWAY, NEW YORK, NY, 10004, US

(21) Appl. No.: 10/414,869

(22) Filed: Apr. 16, 2003

(30) Foreign Application Priority Data
Apr. 26, 2002 (DE) 10218698.7

(51) Int. Cl. B60K 31/00

(52) U.S. Cl. 180/170

(57) ABSTRACT

A driver assistance system for motor vehicles having a plurality of subfunctions which support the driver in handling the vehicle, for example, a speed control function, a distance control function and a warning function, in which an input element permits the driver to switch subfunctions on or off individually.

### FIELD OF THE INVENTION

The present invention relates to a driver assistance system for motor vehicles, having a plurality of subfunctions which support the driver in handling the vehicle.

### BACKGROUND INFORMATION

A typical example for a driver assistance system is a so-called ACC system (adaptive cruise control) as described, for example, in the paper “Adaptive Cruise Control—System Aspects and Development Trends” by Winner, Witte et al., published at the SAE 96 of Feb. 26-29,1996 in Detroit (SAE Paper No. 96 1010). In such an ACC system, the speed of the vehicle is automatically regulated to a desired speed specifiable by the driver. Moreover, the system is equipped with a distance sensor, e.g., a radar sensor, which makes it possible to locate preceding vehicles. When a preceding vehicle is located in one's own traffic lane, then instead of the control to the desired speed, a control to a suitable safety distance relative to the preceding vehicle is carried out. This distance is a function of speed, and therefore is mostly expressed in the form of a time gap T, which is defined as the quotient of the distance and the vehicle's own speed. The ACC system intervenes not only in the drive system of the vehicle, but in certain situations, especially when there is a drop below the safety distance to the preceding vehicle, in the braking system, as well. However, the braking decelerations permitted within the framework of this system are restricted to values which are not uncomfortable or disturbing to the vehicle passengers. In emergency situations in which an acute danger of collision threatens, for example, because a vehicle traveling in the adjoining lane cuts into one's own lane, the intention is that the control remain entrusted to the driver, so that the emergency situation can be safely controlled.

German Patent No. 100 15 299 describes an ACC system in which a warning function is additionally implemented, where a visual and/or acoustical takeover prompt is output to the driver when it is determined on the basis of certain criteria that an acute danger of collision threatens, and therefore an intervention by the driver is necessary.

On the other hand, pure speed control systems without distance control function are known.

The functional scope in known driver assistance systems is established by the manufacturer, and the driver merely has the option of switching the system either on or off, and in the switched-on state, to input the desired speed and possibly further parameters such as the desired time gap. If the manufacturer offers systems having different functional scopes, then the functional scope is established in accordance with the stipulations by the customer.

### SUMMARY OF THE INVENTION

An object of the present invention is to provide a driver assistance system that makes it possible to easily take different customer requests into consideration.

According to the present invention, this objective is achieved by at least one input element which allows the driver to switch subfunctions on or off individually.

Thus, in the system of the present invention, the driver has the possibility of restricting the functional scope, provided by the manufacturer, individually according to his/her own wishes. Therefore, the invention takes into consideration the circumstance that vehicles, particularly those of the luxury class, in which the driver assistance system generally offers a high functional scope, are also purchased by customers who would not want, or at any rate would not always want to take advantage of certain subfunctions of the driver assistance system. Since according to the invention, the driver has the possibility of switching off unwanted subfunctions individually, the logistics of manufacturing and delivering motor vehicles in accordance with the wishes of customers is made easier.

Another advantage of the invention is that the driver has the possibility of switching certain subfunctions on or off depending on mood or the traffic situation. Thus, for example, on a vacation trip and/or when traffic volume is light, the driver will prefer a relaxed manner of driving and will want to take advantage of the full functional scope of the driver assistance program, while in other situations, he/she will more likely feel disturbed by certain subfunctions and would like to switch them off.

The invention is not limited to ACC systems, but is also applicable for driver assistance systems which offer other functions or additional subfunctions going beyond the ACC system, for example, a lateral guidance support in which, depending upon the functional scope, an automatic intervention in the vehicle steering takes place to keep the vehicle at the center of the lane being used, or a lane-departure warning is merely output when the driver comes dangerously close to the boundaries of the lane being used at the moment.

To make a simple and clear operation of the system possible for the driver, in spite of the multitude of different configuration possibilities, it is expedient to arrange several predefined operating modes, which differ in the selection of the active subfunctions, in a succession semi-ordered according to functional scope, and to design the input element so that it is possible to switch through the various operating modes in turn using a single input command. To be understood here by a semi-ordered succession is a succession in which, with rising position figure in the succession, the functional scope either generally increases (semi-order according to rising functional scope) or generally decreases (semi-order according to falling functional scope). For example, in the case of a semi-order according to falling functional scope, the operating modes are then arranged so that for an operating mode having the position figure i, which includes all functions of another operating mode having the position figure j, the relationship i<j is valid.

For an ACC system, the full functional scope may include, for example, the following subfunctions: speed control, distance control and warning function (takeover prompt). The output of a distance correction prompt is preferably provided as a further subfunction. This option may be selected when the distance control is not active. When a significant deviation between the setpoint distance determined by the time gap and the actual distance occurs without the conditions already being present for a takeover prompt or collision warning, the driver then receives the prompt, by way of a visual or acoustical signal, to correct the distance to the preceding vehicle.

In one particularly advantageous specific embodiment, the input element used for selecting the operating mode takes the form of a rotating knob which at the same time has the function of a pushbutton. By operating the pushbutton, one then advances from one operating mode to the next, while by turning the knob, a parameter, i.e. the time gap, which is consequential for the specific selected function, may be changed.

### BRIEF DESCRIPTION OF THE DRAWINGS

FIG. 1 shows a block diagram of a driver assistance system according to the present invention.

FIG. 2 shows a table, in which different operating modes of the driver assistance system as well as associated parameters are indicated.

FIG. 3 shows a schematic perspective representation of an input element for the driver assistance system according to FIGS. 1 and 2.

### DETAILED DESCRIPTION

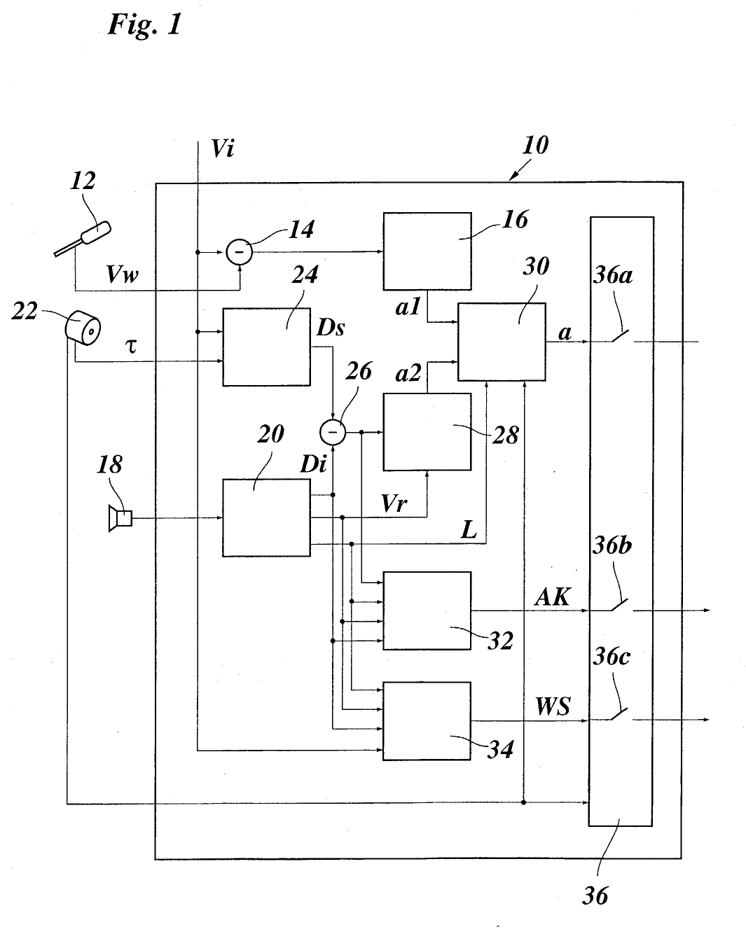

The driver assistance system shown in FIG. 1 is an ACC system 10 for distance and speed control.

With the aid of a multifunctional lever 12 preferably disposed at the steering wheel, the driver is able, as known, to specify a desired speed Vw for the speed control. A brief tap of multifunctional lever 12 upward or downward causes the instantaneous speed of the vehicle to be accepted as the new desired speed. Holding the lever longer in the upward or downward swivelled position causes the desired speed to be increased or decreased stepwise. A subtraction element 14 calculates the difference between desired speed Vw and measured actual speed Vi of the vehicle and supplies a signal, corresponding to the setpoint/actual deviation, to a speed control block 16 which calculates a setpoint acceleration a1 by which the actual speed of the vehicle is brought into agreement with the desired speed. Setpoint acceleration al may also have negative values (deceleration). If the braking torque of the engine is not sufficient to realize this negative setpoint acceleration, an automatic intervention in the braking system of the vehicle is carried out.

A radar sensor 18 locates objects, particularly preceding vehicles, in front of one's own vehicle, and measures their distances, azimuth angles and relative speeds. Based on this data, a detection block 20 checks whether a preceding vehicle is in one's own lane, and selects this vehicle as a target object for the distance control. As output signals, detection block 20 supplies actual distance Di of the target object, its relative speed Vr, as well as a logic signal L that indicates the presence of a target object.

An input element 22, preferably positioned on the center console of the motor vehicle, is used, inter alia, to input a time gap τ which, as a control parameter, is taken as a basis for the distance control. A distance calculation block 24 calculates a setpoint distance Ds for the target object by multiplying time gap τ by actual speed Vi. A subtraction element 26 forms the difference between actual distance Di and setpoint distance Ds of the target object, and supplies a corresponding signal to a distance control block 28 which calculates therefrom a setpoint acceleration a2 for the distance control, taking into consideration relative speed Vr.

From setpoint accelerations a1 and a2, a selection block 30 forms a definitive setpoint acceleration a. This is equal to al when no preceding vehicle was located (L=O), or, for example, is equal to the minimum of a1 and a2 when a distance control to a target object is carried out.

A distance monitoring block 32 receives the signals from detection block 20 and subtraction element 26, and calculates therefrom a distance correction prompt AK which is always output when a preceding vehicle is located and the difference between setpoint distance Ds and actual distance Di of this vehicle lies outside of specific, preferably speed-dependent tolerance limits.

A warning function block 34 receives the signals from detection block 20 and, based on these signals and actual speed Vi, calculates a warning signal WS which is always output when, because of the current values of actual distance Di and relative speed Vr of the located target object, a collision is to be feared, and thus a relatively energetic intervention by the driver is necessary to avert the collision.

Input element 22 in the example shown has at the same time the function of a selector knob, by which various operating modes of ACC system 10 may be selected. The signal which indicates the selected operating mode is routed to selection block 30 and to a function selection block 36. Function selection block 36 fulfills the function of a plurality of switches 36a, 36b, 36c, with which the routing of one or more of the signals a, AK and WS may be blocked depending on the operating mode selected.

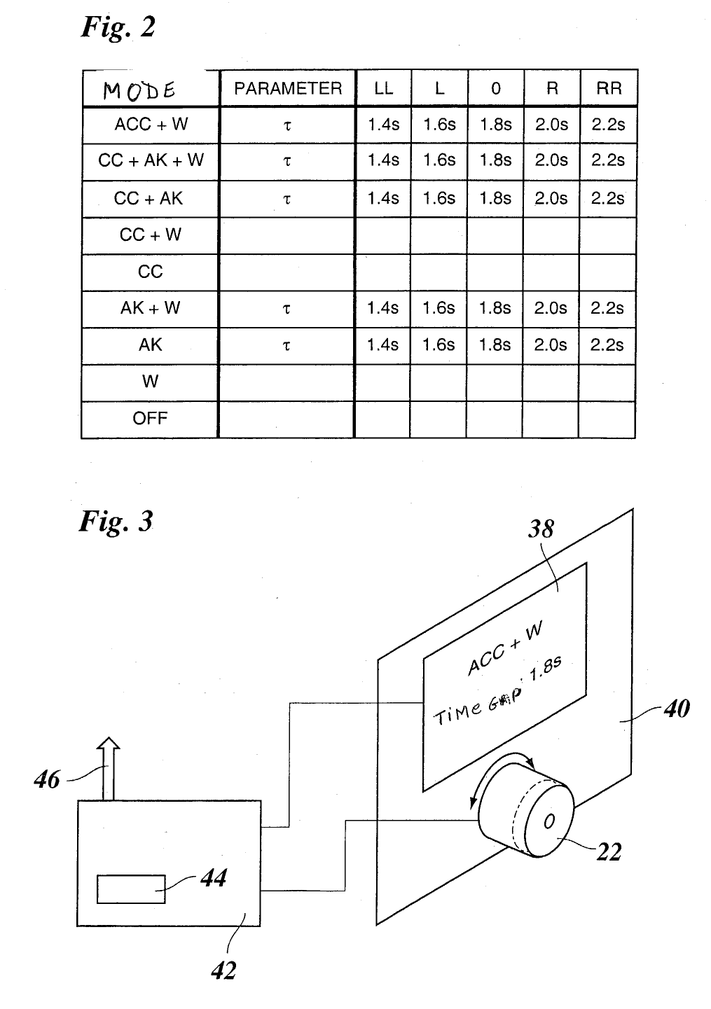

FIG. 2 shows a table in which the available operating modes are listed in turn in the first column. In mode “ACC+W” indicated in the first row, the ACC function, thus speed control and distance control, as well as the warning function of warning function block 34 are active. Accordingly, in this mode switches 36a and 36c are closed, while switch 36b is open. This operating mode corresponds to the maximum functional scope of ACC system 10.

In the next mode “CC+AK+W”, the functional scope is restricted in so far as that, instead of the ACC function, only a speed control is carried out, and instead of the distance control, only distance correction prompt AK is output. In this mode, all switches 36a, 36b and 36c are closed. However, the function of selection block 30 is modified in such a way that only setpoint acceleration a1 from speed control block 16 is always let through as setpoint acceleration a.

The next mode “CC+AK” differs from the previous mode in that switch 36c is open, and therefore the warning function is inactivated.

In subsequent mode “CC+W”, on the other hand, the output of the distance correction prompt is inactivated, and instead, the warning function is active. Consequently, switches 36a and 36c are closed here, and switch 36b is open.

In mode “CC”, merely the speed control is active, and only switch 36a is closed.

The functional scope is restricted even further in mode “AK+W.” Here, neither a distance control nor a speed control takes place. Nevertheless, the distance to the preceding vehicle is monitored, and in response to a deviation from the setpoint distance, distance correction prompt AK is output. If there is danger of collision, warning signal WS is output, which is clearly distinguishable from the distance correction prompt, and signals a greater urgency.

In the next mode “AK”, merely the distance correction prompt is active, i.e. only switch 36b is closed.

Conversely, in the next mode “W”, only the warning function is active, and only switch 36c is closed.

In the last mode “OFF”, all functions are inactive, that is to say, the ACC system is completely switched off.

The method of operation of ACC system 10 in the modes in which the distance control or the distance correction prompt is active is influenced by parameter τ (time gap), as indicated in the corresponding rows in the table according to FIG. 2. In the example shown, time gap T may be set to five different values in the range from 1.4 to _{2.2} s.

FIG. 3 shows an example for the design of input element 22 which permits both the selection of the operating mode and the selection of parameter T and possibly other parameters. Input element 22 is designed here as a rotating knob which at the same time fulfills the function of a pushbutton.

By operating the pushbutton, in each case the operating mode is advanced by one step, corresponding to a jump to the next lower row in FIG. 2. When the lowest row (OFF) is reached, then actuating the pushbutton once more causes the ACC system to switch on, and there is a jump to the topmost row, thus to the mode “ACC+W.”

If a mode has been selected for which time gap τ is a relevant parameter, it is possible to increase or reduce this parameter in steps of 0.2 s by turning input element 22 to the right or to the left. This permits a very ergonomic single-knob operation of ACC system 10. The operating mode set in each instance, as well as, optionally, the valid values for the time gap are indicated in a display 38 which is positioned, for example, above input element 22 in center console 40 of the motor vehicle. Input element 22 and display 38 are connected to a control unit 42 which contains a memory 44 for storing the instantaneous operating mode and the set parameters, and which on its part is connected via a data bus 46, e.g. a CAN bus, to ACC system 10. Control unit 42 receives from input element 22 only signals which indicate that the pushbutton was actuated or that the input element was twisted by a certain angle to the right or to the left. Incidentally, the selection of the operating mode and the time gap takes place in control unit 42.

In addition to time gap τ, other parameters may optionally also be set which are relevant for other operating modes. For example, in the modes in which warning function block 34 is active, a parameter could be set which determines the “pre-warning time” for the collision warning. This parameter would then be set, for instance, by turning adjustment (input) element 22 when the ACC system is in mode

It is also conceivable that a different value would be valid for time gap τ in the ACC mode than in the modes in which only distance correction prompt AK is output.

While in the example shown, all function blocks of the ACC system are constantly active and only the output signals are blocked with the aid of switches 36a, 36c as a function of the operating mode, in a modified specific embodiment, it is also possible to activate the various subfunctions in the manner that the respective function blocks in the ACC system are inactivated directly, or that the parameters used within these function blocks, e.g. the tolerance parameters within warning function block 34, are changed in such a way that the output of the signal is suppressed.

Instead of input element 22 in FIG. 3, a different arrangement of input elements is also conceivable. For example, four arrow buttons may be arranged in the shape of a cross. The arrow button pointing downward is then used for reducing the functional scope (corresponding to pressing the rotating knob in FIG. 3), the arrow button pointing upward makes it possible to increase the functional scope, and the right and left arrow buttons are used for selecting the time gap (corresponding to the turning of the rotating knob).

As a further alternative, the input elements for selecting the functional scope may also be formed by a row of buttons, which are each assigned to one of the operating modes in FIG. 2. A double row having two buttons in each line additionally permits the selection of the parameter, e.g. the time gap. By the first actuation of one of the two buttons, the respective mode is then activated, and with each button pressing in the same line, the parameter is changed.

As a further possibility, the input element may also be formed by multifunctional lever 12 shown in FIG. 1. Until now, this multifunctional lever was only tilted in four directions: upward and downward for setting and increasing or decreasing the desired speed, to the back for canceling the desired speed and to the front for resuming the desired speed. A selection of the functional scope may be achieved by rotating the multifunctional lever about a longitudinal axis. For example, the various operating modes may be assigned different stop locations which lie at angular distances of, for instance, 30°.

What is claimed is:

1. A driver assistance system for a motor vehicle having a plurality of subfunctions which support the driver in handling the vehicle, the system comprising:
at least one input element for allowing the driver to switch subfunctions on or off individually.

2. The driver assistance system according to claim 1, wherein one of the subfunctions is a speed control function.

3. The driver assistance system according to claim 1, wherein one of the subfunctions is a distance control function.

4. The driver assistance system according to claim 1, wherein one of the subfunctions is a warning function which indicates an imminent collision danger to the driver by a warning signal.

5. The driver assistance system according to claim 3, wherein one of the subfunctions is that a distance correction prompt is output when a measured actual distance to a preceding vehicle deviates substantially from a predefined setpoint distance.

6. The driver assistance system according to claim 5, wherein a setpoint distance for distance control is the same as for the distance correction prompt.

7. The driver assistance system according to claim 1, wherein the system has a plurality of predefined operating modes which in each case include a subset of the available subfunctions and are disposed in a succession semi-ordered according to functional scope, and wherein the input element is adapted to advance from one of the operating modes to a next of the operating modes by a single input command.

8. The driver assistance system according to claim 7, wherein the input element includes a pushbutton.

9. The driver assistance system according to claim 8, wherein the input element is constructed at the same time as a rotating knob for selecting a parameter for the operating mode set in each instance.

10. The driver assistance system according to claim 1, further comprising a display for indicating the subfunctions switched on in each case.
